(19) United States
(12) Patent Application Publication
(10) Pub. No.: US 2016/0088816 A1
(43) Pub. Date: Mar. 31, 2016

(54) Insect-Proof Pet Feeder

(71) Applicant: Peter Ramirez, Kerman, CA (US)

(72) Inventor: Peter Ramirez, Kerman, CA (US)

(21) Appl. No.: 14/866,578

(22) Filed: Sep. 25, 2015

Related U.S. Application Data
(60) Provisional application No. 62/055,125, filed on Sep. 25, 2014.

(51) Int. Cl. A01K 5/01

(52) U.S. Cl. CPC A01K 5/0142

(57) ABSTRACT

An insect-proof pet feeder prevents ants and other insects from accessing and contaminating pet food. The pet feeder contains a food feeder and water feeder with feeder lids. The food feeder automatically dispenses food into the food dish. The water feeder automatically dispenses water into the water dish. A water channel surrounds the perimeter of the food dish and creates a mote filled with water to prevent ants and other insects from accessing and contaminating the pet food. The water dish supplies water to the water channel and is elevated to prevent water from traveling back into the water dish.

### CROSS-REFERENCE TO RELATED APPLICATIONS

This Application claims the benefit of U.S. Provisional Application No. 62/055,125, filed Sep. 25, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to pet feeders and in particular to an insect-proof pet feeder for preventing ants and other insects from accessing and contaminating pet food. Pet feeders are normally placed on the floor or ground to provide pets with easy access to food and water. However, due to the location of the feeders, ants and other insects also have access to and can contaminate the pet food. A barrier would prevent ants and other insects from accessing the pet food held in feeders. Using a water barrier, the insect-proof pet feeder resolves the issue of insects accessing and contamination pet food.

### SUMMARY OF THE INVENTION

Accordingly, the invention is directed to an insect-proof pet feeder for preventing ants and other insects from accessing and contaminating pet food. The pet feeder contains a food feeder and water feeder with feeder lids. The food feeder automatically dispenses food into the food dish. The water feeder automatically dispenses water into the water dish. A water channel surrounds the perimeter of the food dish and creates a mote filled with water to prevent ants and other insects from accessing and contaminating the pet food. The water dish supplies water to the water channel and is elevated to prevent water from traveling back into the water dish.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 is a side view of the first exemplary embodiment, displaying the pet feeder 10, food feeder 21, water feed 31, and feeder lids 40.

FIG. 2 is a top view of the first exemplary embodiment, displaying the pet feeder 10, water channel 11, food dish 20, food feeder 21, water dish 30, water feeder 31, and feeder lids 40.

FIG. 3 is a rear view of the first exemplary embodiment, displaying the pet feeder 10, water feeder 31, and feeder lid 40.

FIG. 4 is a front view of the first exemplary embodiment, displaying the pet feeder 10, food feeder 21, and feeder lid 40.

### DETAILED DESCRIPTION OF THE INVENTION

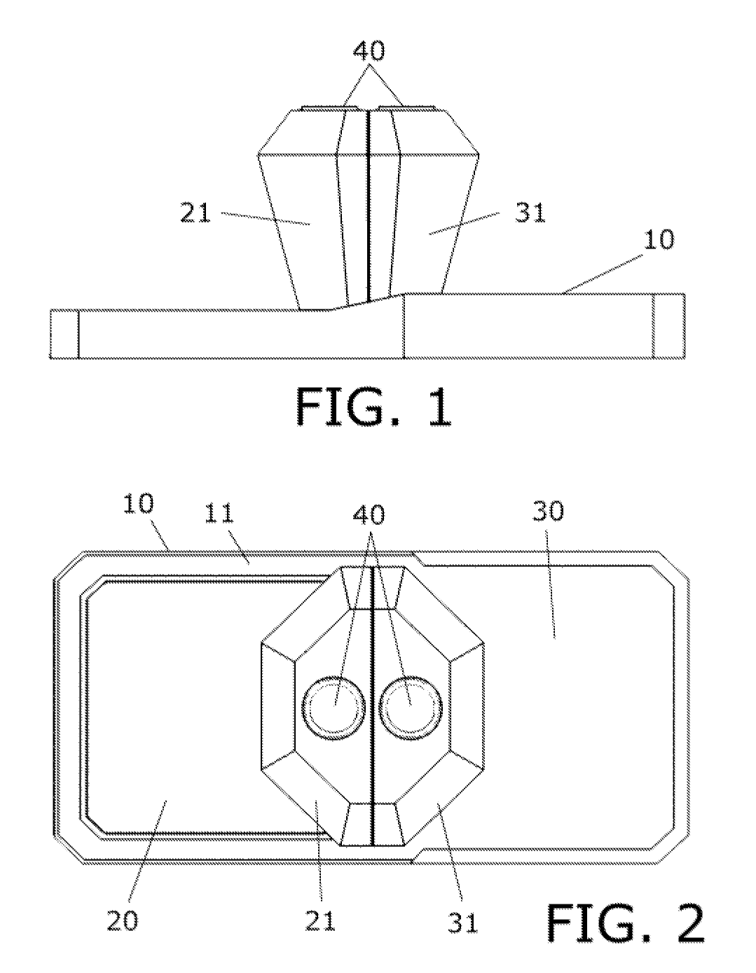

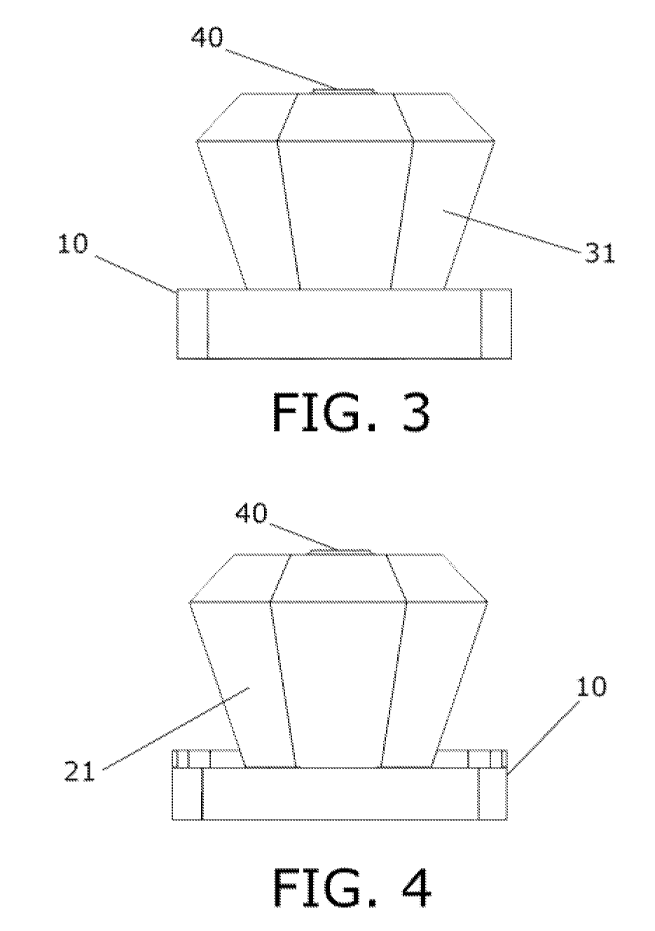

Referring now to the invention in more detail, the invention is an insect-proof pet feeder for preventing ants and other insects from accessing and contaminating pet food. The pet feeder 10 is comprised of a water channel 11, food dish 20, food feeder 21, water dish 30, water feeder 31, and feeder lids 40. FIG. 1, FIG. 2, FIG. 3, and FIG. 4 provide the first exemplary embodiment.

One exemplary embodiment is provided. FIG. 1 and FIG. 2. are the side view and top view of the pet feeder 10, respectively. The food feeder 21 is attached to the food dish 20 and is located adjacent to the water feeder 31. Both the food feeder 21 and food dish 20 can be removed from the pet feeder 10 for cleaning. The food feeder 21 contains a feeder lid 40 that can be removed to insert pet food into the food feeder 21. The food feeder 21 automatically dispenses pet food into the food dish 20 preferably using the force of gravity.

The water channel 11 surrounds the perimeter of the food dish 20 and functions as a mote filled with water to prevent ants and other insects from accessing and contaminating the food dish 20. The water channel 11 is connected to and receives water from the water dish 30. The water dish 30 is elevated relativity to the water channel 11 to prevent water from traveling from the water channel 11 to the water dish 30.

The water feeder 31 is attached to the water dish 30 and is located adjacent to the food feeder 21. The water feeder 31 contains a feeder lid 40 that can be removed to insert water into the water feeder 31. The water feeder 31 automatically dispenses water into the water dish 30 preferably using the force of gravity.

FIG. 3 and FIG. 4 provide the rear view and front view of the pet feeder 10, respectively. The pet feeder 10 and its elements are preferably made of a rigid plastic. Both the food feeder 21 and water feeder 31 preferably made of a clear plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An insect-proof pet feeder, comprising:
(a) a water feeder;
(b) a water dish
(c) a food feeder;
(d) a food dish;
(e) a water channel; and
(f) a pair of feeder lids.
